(19) United States
(12) Patent Application Publication
(10) Pub. No.: US 2021/0087015 A1
(43) Pub. Date: Mar. 25, 2021

(54) ELEVATOR CONTROL DEVICE ELEVATOR SYSTEM AND ELEVATOR CONTROL METHOD

(71) Applicant: Otis Elevator Company, Farmington, CT (US)

(72) Inventor: Xingang Gou, Tianjin (CN)

(21) Appl. No.: 16/829,587

(22) Filed: Mar. 25, 2020

(30) Foreign Application Priority Data
Sep. 25, 2019 (CN) 201910910593.8

(51) Int. Cl. B66B 1/34; B66B 1/24; B66B 1/46; B66B 1/52; B66B 1/50; G06Q 30/02

(52) U.S. Cl. CPC B66B 1/3407; B66B 2201/4676; B66B 1/2458; B66B 1/468; B66B 1/52; B66B 1/50; G06Q 30/0203; B66B 2201/4653; B66B 2201/405; B66B 2201/463; B66B 2201/4661; B66B 2201/101; B66B 2201/103; B66B 2201/104; B66B 2201/231; B66B 2201/213; B66B 2201/4615; B66B 2201/4623; B66B 2201/4638; B66B 1/2408

(57) ABSTRACT

An elevator control device, an elevator system, and an elevator control method. The elevator control device includes: a user interface which receives a user-input instruction and sends it back to an elevator-dispatching control device; and the elevator-dispatching control device, which includes preset elevator-dispatching logic control parameters, modifies one or more elevator-dispatching logic control parameters based on the user-input instruction, and performs an elevator control based on the modified elevator-dispatching logic control parameters.

### FOREIGN PRIORITY

This application claims priority to Chinese Patent Application No. 201910910593.8, filed Sep. 25, 2019, and all the benefits accruing therefrom under 35 U.S.C. § 119, the contents of which in its entirety are herein incorporated by reference.

### FIELD OF THE INVENTION

The present disclosure relates to the field of elevators, and more particularly, the present disclosure relates to an elevator control device including elevator-dispatching logic control parameters that can be flexibly set and adjusted, a corresponding elevator system, and an elevator control method.

### BACKGROUND OF THE INVENTION

An elevator system includes an elevator-dispatching control device, and the elevator-dispatching control device has elevator-dispatching logic control parameters. Existing elevator-dispatching control devices are mainly considered in terms of elevator efficiency.

In addition, the elevator-dispatching logic control parameters of the elevator-dispatching control device can only be set by an elevator provider or modified by a maintenance service provider. For example, the service provider needs to send professionals to the site to make various adjustments, and the parameters cannot be modified based on user's actual experience, making it difficult to meet personalized service requirements.

### SUMMARY OF THE INVENTION

The object of the present disclosure is to solve or at least alleviate the problems existing in the related art.

In one aspect, an elevator control device is provided, which includes: a user interface which receives a user-input instruction and sends it back to an elevator-dispatching control device; and the elevator-dispatching control device, which includes preset elevator-dispatching logic control parameters, modifies one or more elevator-dispatching logic control parameters based on the user-input instruction, and performs an elevator control based on the modified elevator-dispatching logic control parameters.

Optionally, the elevator control device further includes a user information acquisition device, which recognizes user identity information and/or user status information and sends them back to the elevator-dispatching control device, and the elevator-dispatching control device further modifies one or more elevator-dispatching logic control parameters based on the user identity information and/or the user status information.

Optionally, the user interface includes: an elevator-calling device in elevator hall and/or an elevator car control panel.

Optionally, the user interface includes a software interface, and the software interface is located in a terminal device.

Optionally, the software interface issues a survey related to the elevator-dispatching logic control parameters to a user taking the elevator, so as to receive the user-input instruction.

Optionally, the elevator-dispatching logic control parameters include a priority of elevator-dispatching response and a maximum number of stops during a single trip; when the user-input instruction includes an emergency elevator-calling instruction or when the user information acquisition device recognizes an emergency state, the elevator-dispatching control device: a) sets the priority of elevator-dispatching response to the highest, and b) sets the maximum number of stops during a single trip of the elevator performing an emergency elevator-calling task to 1.

Optionally, the elevator-dispatching logic control parameters further include: a maximum acceleration of the elevator, a maximum speed of the elevator, and a stop duration; when the user-input instruction includes an emergency elevator-calling instruction or the user information acquisition device recognizes an emergency state, the elevator-dispatching control device further: c) changes set values of the maximum acceleration and the maximum speed of the elevator performing an emergency elevator-calling task; and d) changes the stop duration of the elevator performing the emergency elevator-calling task.

Optionally, the elevator-dispatching logic control parameters include: a maximum number of stops during a single trip, a minimum time-interval between stops, or a minimum floor-interval between stops.

Optionally, in a case that when the elevator-dispatching control device receives elevator-calling input instructions for a plurality of adjacent floors and the set parameters of the maximum number of stops during a single trip, minimum time-interval between stops or minimum floor-interval between stops cannot be met if a single elevator is dispatched to perform the elevator-calling task, more than one elevators are dispatched to perform the elevator-calling task.

Optionally, the elevator-dispatching logic control parameters include a priority of elevator-dispatching response, the user-input instruction may include information on urgency of elevator-calling, and the elevator-dispatching control device sets the priority of elevator-dispatching response based on the user-input instruction including the urgency of elevator-calling.

Optionally, the elevator-dispatching logic control parameters include a stop duration, the user-input instruction may include information on elevator-calling stop duration, and the elevator-dispatching control device sets the stop duration based on the user-input instruction including the elevator-calling stop duration.

In another aspect, an elevator system is provided, which includes the elevator control device according to various embodiments.

In another aspect, an elevator control method is provided, which includes: receiving a user-input instruction by a user interface and sending it back to an elevator-dispatching control device; modifying one or more elevator-dispatching logic control parameters based on the user-input instruction; and performing an elevator control based on the modified elevator-dispatching logic control parameters.

Optionally, the method further includes: recognizing user identity information and/or user status information by a user information acquisition device, and modifying one or more elevator-dispatching logic control parameters based on the user identity information and/or the user status information.

Optionally, the method further includes: when the user-input instruction includes an emergency elevator-calling instruction or when the user information acquisition device recognizes an emergency state, then perform a) setting a priority of elevator-dispatching response to the highest, and b) setting a maximum number of stops during a single trip of the elevator performing an emergency elevator-calling task to 1.

Optionally, the method further includes: when the user-input instruction includes an emergency elevator-calling instruction or the user information acquisition device recognizes an emergency state, further perform: c) changing set values of a maximum acceleration and a maximum speed of the elevator performing an emergency elevator-calling task; and d) changing a stop duration of the elevator performing the emergency elevator-calling task.

Optionally, the method includes: in a case that when elevator-calling input instructions for a plurality of adjacent floors are received and set parameters of a maximum number of stops during a single trip, a minimum time-interval between stops or a minimum floor-interval between stops cannot be met if a single elevator is dispatched to perform the elevator-calling task, dispatching more than one elevators to perform the elevator-calling task.

Optionally, the method includes: setting a priority of elevator-dispatching response based on the user-input instruction including an urgency of elevator-calling; and/or setting the stop duration based on the user-input instruction including an elevator-calling stop duration.

### BRIEF DESCRIPTION OF THE DRAWINGS

Hereinafter, embodiments according to the present disclosure will be explained with reference to the accompanying drawings. The contents of the present disclosure will become easier to understand with reference to the accompanying drawings.

FIG. 1 shows an elevator system according to an embodiment of the present disclosure.

FIG. 2 shows a simplified structural view of an elevator control device according to an embodiment of the present disclosure.

### DETAILED DESCRIPTION OF THE EMBODIMENT(S) OF THE INVENTION

As mentioned, an elevator-dispatching logic of an elevator-dispatching control device in the related art is preset by the elevator provider and is difficult to modify according to the customer's needs and satisfaction degree. Embodiments of the present disclosure provide improvements in this regard.

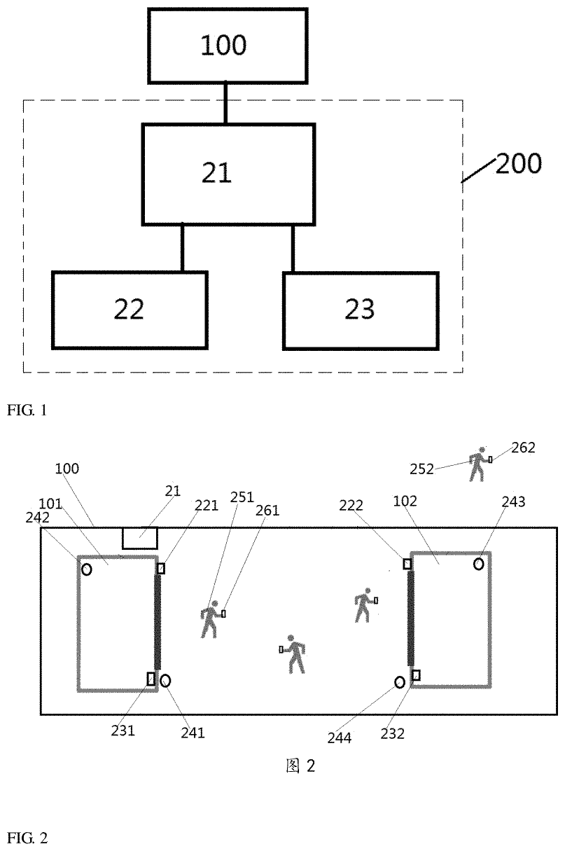

Reference is made to FIG. 1, an elevator system according to an embodiment of the present disclosure is shown, which includes an elevator control device 200 and one or more elevators 100. The elevator control device 200 further includes an elevator-dispatching control device 21, a user interface 23, and an optional user information acquisition device 22. The user interface 23 is configured to receive a user-input instruction. The user information acquisition device 22 is configured to recognize user identity information and/or recognize user status information. The elevator-dispatching control device 21 includes preset elevator-dispatching logic control parameters to control an operation of the elevator. The elevator-dispatching control device 21 is further configured to receive the user-input instruction provided by the user interface 23, modify one or more elevator-dispatching logic control parameters based on the user-input instruction, and perform a control of the elevator 100 based on the modified elevator-dispatching logic control parameters. In some embodiments, the elevator-dispatching control device 21 further receives the user identity information and/or the user status information recognized by the user information acquisition device 22, and modifies one or more elevator-dispatching logic control parameters based on the user identity information and/or the user status information.

With continued reference to FIG. 2, in this specific embodiment, the elevator system includes two elevators 101, 102 and an elevator control device. Specifically, the user information acquisition device 22 of the elevator control device includes a plurality of camera devices, such as camera devices 242, 243 disposed in each elevator car, and camera devices 221, 222 disposed at for example one or more or each elevator hall on each floor. These camera devices may be 2D or 3D camera devices, or may for example have a face recognition function to recognize the user, and they may make a comparison with a building management information base to acquire user identity information, such as name, user's work place, work floor, typical elevator usage time and special requirements. Each camera device may collect user identity information and/or user status information, such as acquiring facial features of the user for face recognition to determine identity information, and acquiring other information related to elevator control and personalized service and associated with the user identity. Functions such as personalized services can be realized by recognizing user information. For example, if Mr. A has a physical abnormality or has difficulty in adapting to frequent starts and stops of elevator, and the maximum elevator speed is too large, then control parameters for the elevator which Mr. A is taking can be changed. For another example, Ms. B has no special requirements on the elevator, so the elevator which Ms. B. is taking can be operated according to normal control parameters. For another example, if Mr. C is a senior manager of a company, when Mr. C's elevator-calling request is recognized, the elevator-calling request can be given the highest priority of response, etc. For another example, each camera device may collect user status information, such as abnormal status. For example, by comparing a captured user image with a feature data image in a database, it may be regarded as a specific status when a similarity reaches a certain level. For example, when the camera device detects that the user's moving speed exceeds a predetermined value, it is determined that the user is running. For another example, the user's expression is compared with a predetermined expression to determine whether the user is in an irritable status. In some embodiments, the user information acquisition device 22 may include a combination of one or more of the camera device, an ID card recognition system, a fingerprint recognition system, a face recognition system, and a voice recognition system. For example, the ID card recognition systems, the fingerprint recognition system, the face recognition system and the voice recognition system may be associated with a building access control to recognize the user identity when the user passes through the access control. Alternatively, these systems may be associated with the elevator-calling device in the elevator hall so that identity authentication is performed before the user enters an elevator-calling instruction, such as when the user swipes a card to take the elevator. The elevator-dispatching control device 21 modifies one or more elevator-dispatching logic control parameters based on the user identity information and/or the user status information to realize personalized services or special functions.

In the embodiment shown in FIG. 2, the user interface 23 of the elevator control device may include: elevator-calling devices 221, 222 in elevator hall and elevator car control panels 231, 232. In addition, the user interface 23 may also include a software interface located such as in a terminal device 261, wherein the software may be provided by an elevator manufacturer or service provider or maintainer. For example, the terminal device may include an interactive interface in an application (app) in the mobile phone of a user 251, and the user may perform an elevator-calling operation and set a target floor via the user interface. In some embodiments, the elevator-calling devices 221, 222 in the elevator hall and the elevator car control panels 231, 232 may serve as a user interface 23 to feedback information to the elevator-dispatching control device 21 to optimize the elevator-dispatching control logic parameters. The elevator-calling devices 221, 222 in the elevator hall and the elevator car control panels 231, 232 may be existing components or may be formed by add some functions on the basis of existing components, such as adding more buttons, adding a long-press function, a function of recognizing multiple presses, etc. Details will be described hereinafter.

In some embodiments, in addition to the existing conventional elevator-dispatching logic control parameters, the elevator-dispatching control device 21 may include one or more of the following parameters: a maximum speed of the elevator, a maximum acceleration of the elevator, a stop duration such as a predicted stop duration at a specific floor and a user-input stop duration at a specific floor, a maximum number of stops during a single trip, a minimum time-interval between stops, a minimum floor-interval between stops, a time the user can wait for, and a priority of elevator-dispatching response. In some embodiments, some of the control parameters may be input by the user, such as the time the user can wait for, the user-input stop duration at a specific floor, etc. For example, the maximum speed of the elevator and the maximum acceleration of the elevator may be set values. After setting, the elevator will run within a range allowed by these set values. The stop duration may be associated the floor information, such as the predicted stop duration at a specific floor and the user-input stop duration at a specific floor. For example, the stop duration may be set to 10 seconds or longer. The minimum time-interval between stops may be a set value. For example, a minimum time interval between two stops may be set to 20 seconds. The setting of the minimum time-interval between stops can prevent the elevator from starting and stopping frequently. The setting of the maximum number of stops during a single trip can be used to avoid repeated stops of the elevator. The single trip refers to a trip before the elevator changes the direction of going up or going down. For example, the maximum number of stops during a single trip may be the maximum number of stops in a single upward trip or the maximum number of stops in a single downward trip. The start floor may be counted or not counted (in all the embodiments described herein, the start floor is not counted). For example, the maximum number of stops during a single trip may be set to 4 to avoid frequent elevator start and stop which cause discomfort to passengers in the car. When elevator-calling signals from more than 4 floors in the same direction are received, two elevators can be dispatched directly to carry out the transportation task. It should be understood by those skilled in the art that the above parameters can be used alone or in combination in case that they do not contradict with each other.

The elevator control device and the elevator system according to the embodiments of the present disclosure provide a flexible and personalized elevator taking experience by elevator-dispatching logic control parameters adaptively modified based on user information and feedback. In the following, functions that can be implemented by the elevator control device according to some specific embodiments of the present disclosure are listed. It should be understood that these functions are merely illustrative and not restrictive. It should be understood that those skilled in the art can develop more functions based on the device of the embodiment of the present disclosure, and the present disclosure is intended to include these equivalent modifications.

In some embodiments, as described above, the device according to the embodiment of the present disclosure can implement user recognition and personalized services, such as setting the elevator-dispatching logic control parameters based on the user identity information. For example, for a user with heart disease, the maximum speed, the maximum acceleration and the like can be reduced. This can be achieved either through a camera device or through a card reader, fingerprint recognition, face recognition, etc.

In some embodiments, the user information acquisition device 22 may recognize an emergency state and/or the user interface 23 may include an emergency state elevator-calling button, and the elevator-dispatching logic control parameters may include a priority of elevator-dispatching response and a maximum number of stops during a single trip. When an emergency state is recognized or when the user-input instruction includes an emergency state, the elevator-dispatching control device 21 can perform below in response to the emergency state: a) sets the priority of elevator-dispatching response to the highest, and/or b) sets the maximum number of stops during a single trip of the elevator performing an emergency elevator-calling task to 1. In some embodiments, the elevator-dispatching logic control parameters may include: a maximum acceleration of the elevator, a maximum speed of the elevator, and a stop duration; in response to the emergency state, the elevator-dispatching control device 21 may further: c) change set values of the maximum acceleration and the maximum speed of the elevator performing an emergency elevator-calling task; and/or d) change the stop duration of the elevator performing the emergency elevator-calling task. The user information acquisition device 22, such as a camera device, can recognize an emergency elevator-calling by determining events such as user running or facial expression irritability or looking around or stomping, as described above; alternatively, for example, when the user's physical discomfort is recognized such as vomiting or being supported by others with the hand, or when it is recognized that the user is performing an emergency task, such as firefighter or police performing a task, or when other images that can recognize that the user is in an emergency state are recognized, it is determined that the above emergency state is recognized. As is known in the art, these recognitions can each be implemented by a 2D or 3D camera device in combination with an algorithm, such as comparing a captured image with a preset image and recognizing based on a similarity of them. In some embodiments, when the user information acquisition device 22 may include an ID card recognition device, an ID card with an emergency elevator-calling function may be configured for the building management personnel to recognize by swiping the card when needed. In addition, in the user interface 23 such as an application program interface of the user, the elevator-calling devices 221, 222 in the elevator hall and the elevator car control panels 231, 232 may include emergency elevator-calling buttons. The emergency elevator-calling buttons may be, for example, separate buttons, or may be implemented by long pressing the elevator-calling buttons of the elevator-calling devices 221, 222 in the elevator hall, or pressing the conventional elevator-calling buttons for multiple times within a short time. In some embodiments, for the above behavior a), for example, the control system will ignore other elevator-calling requests with lower priorities, and will directly dispatch an elevator to perform the transportation task. For the above behavior b), it means that the elevator performing the emergency elevator-calling task will directly reach the target floor without making a stopover. For the above behavior c), for example, the maximum speed can be increased, and the maximum acceleration can be decreased, so that the elevator can complete the transportation task more smoothly and quickly. Alternatively, the maximum speed can be decreased or the maximum acceleration can be increased. For the above behavior d), for example, the stop duration of the elevator is increased to facilitate the user with a physical discomfort to take the elevator. Through the above settings, the emergency elevator-calling function is realized, so that the elevator system can respond to the emergency elevator-calling request as soon as possible, and can meet the special needs of users in an emergency state.

In some embodiments, the elevator control device according to the embodiment of the present disclosure can realize differentiated elevator-calling requests, thereby optimizing elevator scheduling and allocation and improving elevator system efficiency. In some embodiments, the user-input instruction may include calling-related information, and the elevator-dispatching logic control parameters may be modified based on the information. For example, the user-input instruction may include information on urgency of elevator-calling. For example, the user interface, such as a conventional user interface or an application program interface of a terminal device, may include a plurality of elevator-calling buttons differentiated based on the urgency of elevator-calling, such as buttons of emergency elevator-calling, conventional elevator-calling, elevator-calling and can wait, option of waiting time, elevator-calling reservation, etc. The user can choose a corresponding button to perform the elevator-calling operation according to his/her own situation, and the elevator-dispatching control device can set the priority of elevator-dispatching response based on an elevator-calling emergency setting instruction so as to optimize elevator allocation. For example, a mechanism may be created to encourage users to reserve the elevator taking. For example, after waiting for a certain period of time, the user who reserved the elevator taking may call the elevator again if he/she needs to take the elevator, and the calling may have a high priority. In some embodiments, the user-input instruction may include information on elevator-calling stop duration. In some embodiments, the user interface, such as a conventional user interface or an application program interface of a terminal device, may include a plurality of elevator-calling buttons differentiated based on the elevator-calling stop duration, such as a regular stop, a middle time stop, a long time stop, etc. The elevator-dispatching control device sets the stop duration based on an elevator-calling stop duration setting instruction. This setting enables the elevator to be stopped longer when the user has special requirements, such as having physical inconvenience or transporting cargos, without the need to repeatedly press a door-opening button to keep the elevator stopped. In other embodiments, the user-input instruction may include other information; for example, the user interface, such as a conventional user interface or an application program interface of a terminal device, may include an elevator-calling button containing the user's special requirements, such as calling when carrying a pet, calling when on a wheelchair, etc. In some embodiments, the system repeatedly reminds the user to avoid mis-operation and facilitates cancellation of wrong operation. In some embodiments, the application may have a blacklist system. For example, if a user maliciously performs an emergency calling without an emergency situation, the user will be added to the blacklist to block the emergency elevator-calling button for this user in the application. From the above, it can be seen that the elevator control device according to the embodiment of the present disclosure can change control parameters in response to actual user requirements, thereby providing personalized services.

In some embodiments, the setting of a combination of one or more of the parameters of the maximum number of stops during a single trip, the minimum time-interval between stops or the minimum floor-interval between stops can prevent the elevator from stopping repeatedly, thereby preventing passengers in the elevator or passengers waiting for the elevator from feeling uncomfortable. By setting these parameters, elevator control can be optimized. For example, in a case that when elevator-calling set instructions for a plurality of adjacent floors are received by the elevator-dispatching control device and at least one of the set parameters of the maximum number of stops during a single trip, the minimum time-interval between stops or the minimum floor-interval between stops cannot be met if a single elevator is dispatched to perform the elevator-calling task, two or more elevators are dispatched to perform the elevator-calling task. Based on these parameters, the elevator control device according to the embodiment of the present disclosure can improve the user experience in take elevator.

In some embodiments, the user interface includes a software interface in a terminal device, the user interface sends a survey to the user taking the elevator, which is related to the elevator-dispatching logic control parameters, to receive feedback from the user as user-input information, and the elevator control device modifies the elevator-dispatching logic control parameter based on the feedback from user. For example, a survey may be conducted for users to know about the stop duration; and if most users think that the stop duration is too short, the parameter of stop duration may be modified. As another example, a survey may be conducted for users to know about the number of stops; and if most users think that the number of stops is too large, the maximum number of stops during a single trip may be appropriately reduced. As further another example, a survey may be conducted for users to know about the elevator speed; and if most users think that the elevator speed is too fast, the maximum speed of elevator may be reduced. Based on this function, elevator parameters can be set based on feedback from the user, thereby substantively improving the user experience in taking elevator.

On the other hand, embodiments of the present disclosure also provide an elevator system and an elevator control method. The elevator system includes the elevator control device according to various embodiments, and the elevator control method includes: recognizing a user through a user information acquisition device, and collecting user information and/or user status; receiving a setting instruction actively input by the user through a user interface; modifying one or more elevator-dispatching logic control parameters based on the user information, the user status and/or the setting instruction actively input by the user; and performing elevator-dispatching and control based on the modified elevator-dispatching logic control parameters.

The elevator control device and the elevator system according to various embodiments of the present disclosure each provide the user with a personalized elevator-taking service and improve the user experience in taking elevator.

The specific embodiments described above are merely for describing the principle of the present disclosure more clearly, and various components are clearly illustrated or depicted to make it easier to understand the principle of the present disclosure. Those skilled in the art can readily make various modifications or changes to the present disclosure without departing from the scope of the present disclosure. It should be understood that these modifications or changes should be included within the scope of protection of the present disclosure.

What is claimed is:

1. An elevator control device, comprising:
a user interface which receives a user-input instruction and sends it back to an elevator-dispatching control device; and
the elevator-dispatching control device, which comprises preset elevator-dispatching logic control parameters, modifies one or more elevator-dispatching logic control parameters based on the user-input instruction, and performs an elevator control based on the modified elevator-dispatching logic control parameters.

2. The elevator control device according to claim 1, wherein the elevator control device further comprises a user information acquisition device, which recognizes user identity information and/or user status information and sends them back to the elevator-dispatching control device, and the elevator-dispatching control device further modifies one or more elevator-dispatching logic control parameters based on the user identity information and/or the user status information.

3. The elevator control device according to claim 1, wherein the user interface comprises: an elevator-calling device in elevator hall and/or an elevator car control panel.

4. The elevator control device according to claim 1, wherein the user interface comprises a software interface, and the software interface is located in a terminal device.

5. The elevator control device according to claim 4, wherein the software interface issues a survey related to the elevator-dispatching logic control parameters to a user taking the elevator, so as to receive the user-input instruction.

6. The elevator control device according to claim 1, wherein the elevator-dispatching logic control parameters comprise a priority of elevator-dispatching response and a maximum number of stops during a single trip; when the user-input instruction comprises an emergency elevator-calling instruction or when the user information acquisition device recognizes an emergency state, the elevator-dispatching control device: a) sets the priority of elevator-dispatching response to the highest, and b) sets the maximum number of stops during a single trip of the elevator performing an emergency elevator-calling task to 1.

7. The elevator control device according to claim 6, wherein the elevator-dispatching logic control parameters further comprise: a maximum acceleration of the elevator, a maximum speed of the elevator, and a stop duration; when the user-input instruction comprises an emergency elevator-calling instruction or the user information acquisition device recognizes an emergency state, the elevator-dispatching control device further: c) changes set values of the maximum acceleration and the maximum speed of the elevator performing an emergency elevator-calling task; and d) changes the stop duration of the elevator performing the emergency elevator-calling task.

8. The elevator control device according to claim 1, wherein the elevator-dispatching logic control parameters comprise: a maximum number of stops during a single trip, a minimum time-interval between stops, or a minimum floor-interval between stops.

9. The elevator control device according to claim 8, wherein in a case that when the elevator-dispatching control device receives elevator-calling input instructions for a plurality of adjacent floors and the set parameters of the maximum number of stops during a single trip, minimum time-interval between stops or minimum floor-interval between stops cannot be met if a single elevator is dispatched to perform the elevator-calling task, more than one elevators are dispatched to perform the elevator-calling task.

10. The elevator control device according to claim 1, wherein the elevator-dispatching logic control parameters comprise a priority of elevator-dispatching response, the user-input instruction may comprise information on urgency of elevator-calling, and the elevator-dispatching control device sets the priority of elevator-dispatching response based on the user-input instruction comprising the urgency of elevator-calling.

11. The elevator control device according to claim 1, wherein the elevator-dispatching logic control parameters comprise a stop duration, the user-input instruction may comprise information on elevator-calling stop duration, and the elevator-dispatching control device sets the stop duration based on the user-input instruction comprising the elevator-calling stop duration.

12. An elevator system, comprising the elevator control device according to claim 1.

13. An elevator control method, comprising:
receiving a user-input instruction by a user interface and sending it back to an elevator-dispatching control device;
modifying one or more elevator-dispatching logic control parameters based on the user-input instruction; and
performing an elevator control based on the modified elevator-dispatching logic control parameters.

14. The elevator control method according to claim 13, further comprising:
recognizing user identity information and/or user status information by a user information acquisition device, and
modifying one or more elevator-dispatching logic control parameters based on the user identity information and/or the user status information.

15. The elevator control method according to claim 13, further comprising: when the user-input instruction comprises an emergency elevator-calling instruction or when the user information acquisition device recognizes an emergency state, then perform a) setting a priority of elevator-dispatching response to the highest, and b) setting a maximum number of stops during a single trip of the elevator performing an emergency elevator-calling task to 1.

16. The elevator control method according to claim 15, further comprising: when the user-input instruction comprises an emergency elevator-calling instruction or the user information acquisition device recognizes an emergency state, further perform c) changing set values of a maximum acceleration and a maximum speed of the elevator performing an emergency elevator-calling task; and d) changing a stop duration of the elevator performing the emergency elevator-calling task.

17. The elevator control method according to claim 13, comprising: in a case that when elevator-calling input instructions for a plurality of adjacent floors are received and set parameters of a maximum number of stops during a single trip, a minimum time-interval between stops or a minimum floor-interval between stops cannot be met if a single elevator is dispatched to perform the elevator-calling task, dispatching more than one elevators to perform the elevator-calling task.

18. The elevator control method according to claim 13, comprising:
setting a priority of elevator-dispatching response based on the user-input instruction comprising an urgency of elevator-calling; and/or
setting the stop duration based on the user-input instruction comprising an elevator-calling stop duration.
